(19) United States
(12) Patent Application Publication
(10) Pub. No.: US 2007/0095292 A1
(43) Pub. Date: May 3, 2007

(54) Modular pet bed

(76) Inventor: Deborah Musselman, Rocklin, CA (US)

Correspondence Address: K. Brian Matlock, 1004 Northoak Dr., Walnut Creek, CA, 94598, US

(21) Appl. No.: 11/263,362

(22) Filed: Oct. 31, 2005

(51) Int. Cl. A01K 29/00

(52) U.S. Cl. 119/28.5

(57) ABSTRACT

A modular, multi-level Pet Bed, interlocking reversible/removable platform base and vertical support pillar assembly which is configurable with multiple platforms using common recycled, environmentally friendly materials and optional pet house Hideaway structures. The assembly forms a multiple level pet bed and platform with a notched and grooved horizontal and vertical support pillar frame. The vertical support pillars are easily configured with hook and loop carpet remnants to serve as a pet scratching post.

### BACKGROUND

1. Field of the Disclosure

This invention relates generally to apparatus for pets bedding but specifically relates to modular, multi-level pet beds, pillars, supports and platforms.

2. The Prior Art

Background

Beds for pets and support members used in the construction of the frame to hold a pet mattress are well known in the art. However, existing designs do not accommodate multiple platform levels and are not interlocking to structural support pillars. They engage a target surface in a substantially single level orientation through a frame to hold pets. Considering limitations of existing products, a multiple level platform design provides elevated protection rather than merely resting on a flat surface. Further, the multiple platform design improves the prior art by providing optional, detachable and removable, pet house hideaways and pet scratching posts. Finally, the prior art designs do not allow for recycled, environmentally friendly construction members in a modular, notched and grooved assembly, configurable for multiple pets.

### BRIEF DESCRIPTION OF THE DRAWING FIGURES

FIG. 1 is a Modular Pet Bed assembly with a large bottom container and notched and grooved vertical support members.

### DRAWING REFERENCE NUMERALS

1 Pet scratching, vertical support pillars
2 Removable/Reversible platform base
3 Drilled opening for stretch cord or truck bed tie down
4 Removable hook and loop attached remnant carpeting
5 Carved notches for platforms support
6 Carved notches with leg options for platforms support and elevation
7 Optional pet house hideaway
8 Upper horizontal support members interlocking with vertical pillars
9 Painted or stained trim finish post caps and covers

### DETAILED DESCRIPTION

Persons of ordinary skill in the art will realize that the following description is illustrative only and not in any way limiting. Other modifications and improvements will readily suggest themselves to such skilled persons having the benefit of this disclosure. In the following description, like reference numerals refer to like elements throughout.

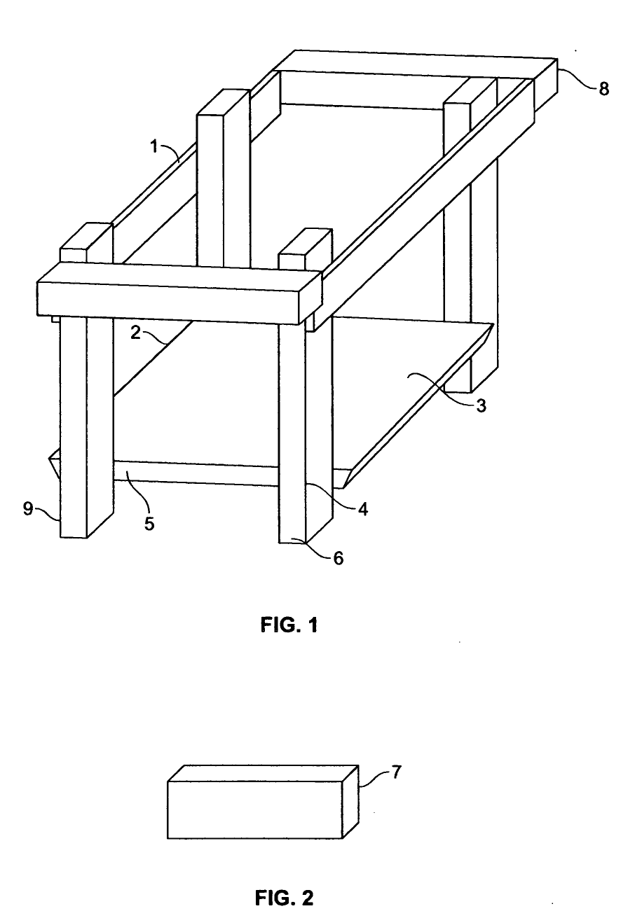

FIG. 1 is a top and side view of a modular Pet Bed, multiple platform mount assembly with a bottom platform base and removable, reversible platform base 2 and a top platform mounting area 8 attached via notch and groove construction.

FIG. 1 further illustrates pet scratching, horizontal members notched and attached to vertical support pillars 6 and carved notches for platform support 5 modularly attached by interlocking notches. The bottom platform base and removable, reversible platform features a drilled opening provided for stretch cords, pet leashes for truck bed tie down 3. The pet scratching pillars are formed by a removable hook and loop system attaching remnant carpet continuously and smoothly joined or tacked to the vertical support members. The edges of said front, first side, rear, second side, top and bottom panels are also formed continuously and smoothly in a variety of environmentally friendly materials including composition fiber, wood, and recycled particle, composition pressed wood.

What is claimed is:

1. A modular, portable, multi-level Pet Bed assembly comprising:
a bottom platform formed of front, side, rear, top and bottom panels;
modularly attached to corner vertical member supports;
a top level platform formed of front, side, rear, top and bottom panels;
modularly attached to corner vertical member supports;

2. The apparatus of claim 1 further comprising:
a means for multi-level, pet bedding, house and scratching pillars.

3. The apparatus of claim 2 wherein
a said multi-level modular pet bed is selected from the group consisting of a wood particle material, a composite material, and a wood lumber material.

4. A method for containing and bedding pets, comprising the steps of:
housing said pets in a multi-level pet bed, and providing said pet bed assembly for pet scratching on vertical, carpet wrapped pillars suitable for pet scratching and vertical structural support.

5. The apparatus of claim 2 wherein
said bottom platform is reversible and removable in one piece with a variety of internal materials comprising ceramic tile, wood and/or carpeting;
said bottom platform comprising front, side and rear panels in varying thicknesses;
said front, rear and side panels shaped in a rectangular edge to a substantially horizontal bottom panel;
said bottom panel joined in a substantially perpendicular edge to said front, rear and side panels.
